(19) United States
(12) Patent Application Publication
(10) Pub. No.: US 2020/0062575 A1
(43) Pub. Date: Feb. 27, 2020

(54) GRAVITY TAPPING SYSTEM AND METHOD

(71) Applicant: Riley Sullivan, Kirkland, WA (US)

(72) Inventor: Riley Sullivan, Kirkland, WA (US)

(21) Appl. No.: 16/547,187

(22) Filed: Aug. 21, 2019

Related U.S. Application Data
(60) Provisional application No. 62/721,531, filed on Aug. 22, 2018.

(51) Int. Cl. B67D 3/00; B67D 3/04

(52) U.S. Cl. CPC B67D 3/0032; B67D 3/047

(57) ABSTRACT

The disclosure presented herein relates to a tapping device that may be used to dispense liquid from a liquid container. The tapping device may include multiple methods for attaching to a liquid container and siphoning air from outside the growler to assist in dispensing the liquid inside of the liquid container, such as by various air valves located on the tapping device's shank to allow air flow during use.

### CROSS-REFERENCE TO RELATED APPLICATIONS

This application claims the benefit of U.S. Provisional Application No. 62/721,531 filed on Aug. 22, 2018.

### FIELD OF THE DISCLOSURE

This disclosure relates generally to the field of a tapping device, a closure system, and method for drawing fluid from an existing fixed volume liquid container through a tapping device using atmospheric pressure and gravity.

### BACKGROUND

Brewers and servers of craft beer often offer growlers as a convenient container to bring home beer from the brewery or establishment where it is served. Beer drinkers often prefer to keep their beverages cold, out of the sunlight to prevent UV rays from skunking the beer, and to keep the beer in an air tight container to prevent loss of the beer carbonation that cause flat beer and oxygen exposure that can also deteriorate the taste of beer.

Beer drinkers have come up with many solutions to maintain the quality of their beer for consumption over the years. One popular solution is to use a brown glass growler bottle that prevents most of the UV rays from reaching the beer. Other solutions include keeping the beer in the refrigerator and using air tight screw on threaded cap bottles or growlers to prevent carbonation from leaking out of the beer and oxygen from being exposed to the beer.

These traditional growler bottles have solved many of the problems of keeping the beer fresh, but often present new problems as the threaded small openings that are used to limit the amount of oxygen exposure and carbonation loss on the large growlers make it difficult and time consuming to pour the beer out of the large growlers. This problem is amplified when a user is trying to pour a growler into a glass at a certain angle to correctly pour the beer into a glass.

There have been some attempts to solve the problems in the prior art, including pouring devices aimed at addressing the difficulty of pouring or dispensing beer out of a growler. Many of these pouring devices require proprietary growler designs that use pressure, either with CO₂ cartridges or pumps to dispense the beer. They are often very expensive and require continuous CO₂ in order to work. The pump designs take a lot of effort in order to use the pumps.

U.S. patent application Ser. No. 15/354,817 is an example of existing attempts to address the shortcomings of conventional growler pouring devices. This patent describes a closure system for sealing a grower and dispensing the beer under the influence of gravity through a conventional tap faucet. In this existing patent, the tap faucet uses a collapsible bladder located inside of the growler. As part of its closure system, any air or gas that would typically fill the headspace of the growler as the beverage is poured out instead of trapped inside the collapsible bladder. This patent application, however, does not sufficiently provide a fast or steady enough pour solution to existing growler tap devices.

Due to all of the existing shortcoming in presently available devices, there is still a need for a tapping device that allows for easy uncomplicated use, providing a steady pour, and beer quality maintained by dispensing from a growler without the use of CO₂ or pumping. The presently disclosed tapping device addresses these needs by providing a tapping device that is easy to use and attaches to a liquid container to provide a system and method of dispensing liquid with the use of gravity.

### SUMMARY

The disclosure presented herein relates to a tapping device that works with a self-sealing straw or siphoning device, to siphon air inside of a growler to assist in the dispensing of liquid through the tapping device with gravity and atmospheric pressure. In one or more non-limiting examples, a tapping device as described in one or more embodiments herein may be used as a tapping device for dispensing beer from a growler. Those of ordinary skill will appreciate that other uses may be foreseeable also and are included within the scope of the present description.

In one aspect, one or more embodiments for a tapping device are provided in the present description, whereby the tapping device includes a shank, one or more connecting heads, one or more air valves, and an exit port. Further, the one or more embodiments of the present tapping device may comprise one or more self-sealing straws that are capable of connecting to one or more of the valves and siphoning air from outside of a growler to inside of said growler.

In another aspect, one or more embodiments for a closure system and method for drawing fluid from existing fixed volume liquid containers through a tapping device using atmospheric pressure and gravity is provided. The exemplary closure system and method may include a tapping device, a straw siphon, and a tap handle.

In another aspect, one or more embodiments for a tapping system are provided in the present description, whereby the tapping system includes a tapping device, the tapping device having an exit port and a container. The container may be configured to connect to the tapping device in an inverted position, whereby the container is configured to hold a liquid, and a faucet. The faucet may be configured that when opened, the liquid in the container flows under the forces of gravity and atmospheric pressure from the container through the tapping device and out the faucet. The tapping system may further include an air valve, whereby the air valve has a first end and a second end, whereby the first end of the air valve is located internally within the tapping device and the second end of the air valve is located externally of the tapping device. The tapping system may further include a straw, whereby the straw is connected to the first end of the air valve. The tapping system may further include a shank, whereby the shank has a curved, tubular shape with a solid, round exterior and hollow interior configured to facilitate the flow of the liquid, with the first end of the air valve reaching internally into the shank. Further, the tapping system may include a connecting head configured to connect the tapping device to the container, whereby the connecting head has a disk shape with a lower disk-shaped surface and a cylindrical side surface having a plurality of parallel striations defined thereon, and the cylindrical side surface of the connecting head is threaded on an inside surface configured to permit the tapping device to screw onto the container.

In another aspect, one or more embodiments for a tapping system are provided in the present description, whereby the tapping system comprises a tapping device, the tapping device having an exit port and a container. The container may be configured to connect to the tapping device in an inverted position and the container may be configured to hold a liquid. The tapping system may further include a faucet, whereby the faucet is configured that when opened, the liquid flows under the forces of gravity and atmospheric pressure from the container through the tapping device and out the faucet. The tapping system may further include a straw, whereby the straw includes a self-sealing mechanism, whereby the self-sealing mechanism includes a bottom seal, a ball, and a top holder. The self-sealing mechanism may be configured that when the faucet is in a closed position, the liquid does not flow through the tapping device from container, and the ball rests upon the bottom seal, preventing oxygen from getting inside of the container, and any carbonation of the liquid inside of the container from leaking out. Conversely, when the faucet is an open position, the liquid flows through the tapping device from the container, whereby the atmospheric pressure inside of the container may cause the ball to push off the bottom seal. Further, in one embodiment, the top holder of the self-sealing mechanism may have grooves around an outer circumference configured to permit air to flow out of a top of the straw, as to prevent the ball from blocking air flow at the top of the straw. Further, the faucet of the tapping system may include an internal valve that is opened or closed with a handle, wherein handle is configured such that when moved to an open position, a faucet valve is opened, and the liquid will flow through the faucet, the straw an elongated tube, the straw configured to connect to an air valve, the air valve having a first end and a second end, whereby the first end of the air valve is located internally within the tapping device and the second end is located externally of the tapping device. The tapping system may further include a shank, the shank having a curved tubular shape with a solid, round exterior and hollow interior configured to facilitate the flow of the liquid, the first end of the air valve reaching internally into the shank.

In another aspect, one or more embodiments for a tapping system are provided in the present description, whereby the tapping system may include a tapping device. The tapping device may have an exit port as well as a container, whereby the container is configured to connect to the tapping device in an inverted position. Further, the container may be configured to hold a liquid. The tapping system may further include a faucet, whereby the faucet is configured that when opened, the liquid flows under the forces of gravity and atmospheric pressure from the container through the tapping device and out the faucet. The tapping system may further include a shank, whereby the shank is configured to facilitate the flow of the liquid. In one embodiment, the shank may have an L-shape. Further, the shank may include a base whereby the base is configured to support the weight of the container and the faucet. Further, in one embodiment, the container and the faucet may be configured to not rotate when the tapping device is placed on an edge of a surface and the faucet is hanging over the surface. In one embodiment, the faucet may include an internal valve that is opened or closed with a handle, whereby the handle is configured such that when moved to an open position, a faucet valve is opened, and the liquid can flow through the faucet. Further, the present, exemplary tapping system may include an air valve, whereby the air valve includes a first end and a second end, whereby the first end of the air valve is located internally within the tapping device and the second end is located externally of the tapping device.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is an illustration of an exemplary tapping device according to various aspects of the present disclosure.

FIG. 2 is a perspective view of the tapping device of FIG. 1.

FIG. 3 is a side view of the tapping device of FIG. 1 without a siphoning straw or faucet attached according to various aspects of the present disclosure.

FIG. 4 is a top down view of the exemplary tapping device as shown in the FIG. 3 view.

FIG. 5 is a front view of the exemplary tapping device as shown in the FIG. 3 view.

FIG. 6 is a perspective view of the tapping device as shown in the FIG. 3 view.

FIG. 7 is a sectional view of the exemplary tapping device as shown in the FIG. 3 view.

FIG. 8 is a perspective view of an exemplary tapping device according to various aspects of the present disclosure.

FIG. 9 is a sectional view of the exemplary tapping device as shown in FIG. 8.

FIG. 10 is a perspective view of the components that make up the siphoning straw shown in, for example, FIG. 1, of the exemplary tapping device according to various aspects of the present disclosure.

FIG. 11 is a side view of the siphoning straw shown in, for example, FIG. 1, of the exemplary tapping device according to various aspects of the present disclosure.

FIG. 12 is a perspective view of one example of the components that may be used to make a siphoning straw.

FIG. 13 is a perspective view of the FIG. 12 components, shown in the order they would be placed inside of a siphoning straw, in one exemplary embodiment.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for various tapping devices that may be used to dispense liquid from a liquid container. In one or more embodiments, an included tapping device may include multiple methods for attaching to a growler or liquid container and siphoning air from outside the growler to assist in dispensing the liquid inside of the liquid container. For example, in one or more embodiments, various air valves may be located on the tapping device's shank to allow air flow during use. The tapping devices, in one or more embodiments, may be combined with other methods to allow for a more flexible method of dispensing liquid from a liquid container. Elements included herein are meant to be illustrative, rather than restrictive. Persons having ordinary skill in the art relevant to the present disclosure may understand there to be equivalent elements that may be substituted with the present disclosure without changing the essential function or operation of the device.

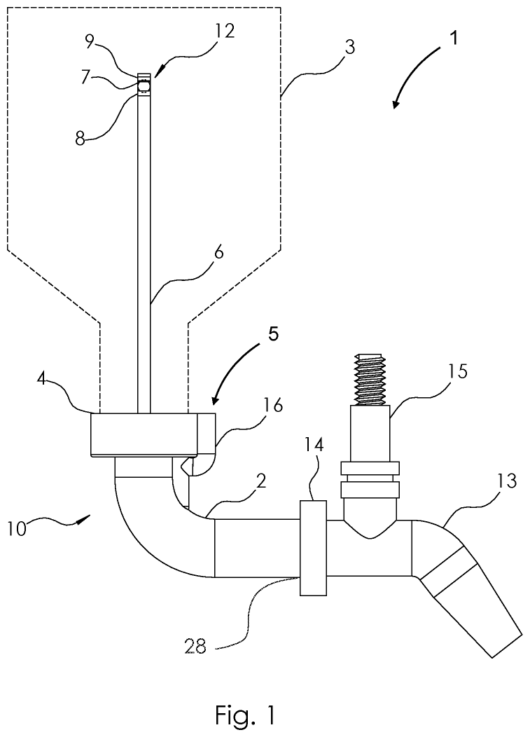

With reference now to FIG. 1, one exemplary embodiment of a gravity tapping system, labeled as gravity tapping system 1 in FIG. 1 is generally designated. Gravity tapping system 1 may include a tapping device such as tapping device 10, a liquid container, such as liquid container 3, a siphoning straw, such as siphoning straw 6, and a faucet, such as faucet 3. In one or more embodiments, tapping device 10 may be used along with liquid container 3 to dispense liquid from liquid container 3 without limitation. In one non-limiting embodiment, liquid container 3 may be a growler commonly used for beer and other beverages. The term “liquid container” (e.g. liquid container 3) may interchangeably be referred to as a glass, growler, or bottle. It is noted that the shape of liquid container 3, as shown in FIG. 1, is exemplary only, and that liquid container 3 may have any shape and be of any size when used with the one or more embodiments of gravity tapping system 1.

In this embodiment, liquid container 3 may be connected to tapping device 10 in an inverted position, and faucet 13 may be attached to the exit end of tapping device 10 with a connector such as connector 14. In operation, when faucet 13 is opened, liquid will flow under the forces of gravity and atmospheric pressure from liquid container 3 through tapping device 10 and out of the exit port for faucet 13.

In one or more embodiments, this tapping device 10 may include a shank, such as shank 2. In one non-limiting embodiment, shank 2 of tapping device 10 may be generally a curved, tubular shape with a solid round exterior and hollow interior adapted to facilitate the flow of liquid. In another embodiment, tapping device 10 may be of any preferred shape or size. Further, this tapping device 10 may be integrally formed or made as a combination of one or more elements, and may be formed of any material known in the art.

Tapping device 10 shown in FIG. 1 may further include a connecting head such as connecting head 4 located at one end of shank 2. Connecting head 4 is capable of connecting tapping device 10 to liquid container 3. In one embodiment, connecting head 4 has a disk shape with a lower disk-shaped surface, and a cylindrical side surface having a plurality of parallel striations defined thereon. In another alternative embodiment, the cylindrical side surface of connecting head 4 may be threaded on the inside surface to allow tapping device 10 to screw onto a liquid container 3. In this embodiment, the cylindrical side surface of connecting head 4 can rotate in order to allow a user to screw connecting head 4 onto a liquid container 3. Further, in this embodiment, a rubber seal, or any material known in the art, can be placed inside connecting head 4 in order to prevent liquid from leaking. In one non-limiting embodiment, tapping device 10 may have more than one connecting heads, such as connecting head 4, to allow a user to dispense liquid from multiple liquid containers (e.g. such as liquid container 3) using one tapping device 10.

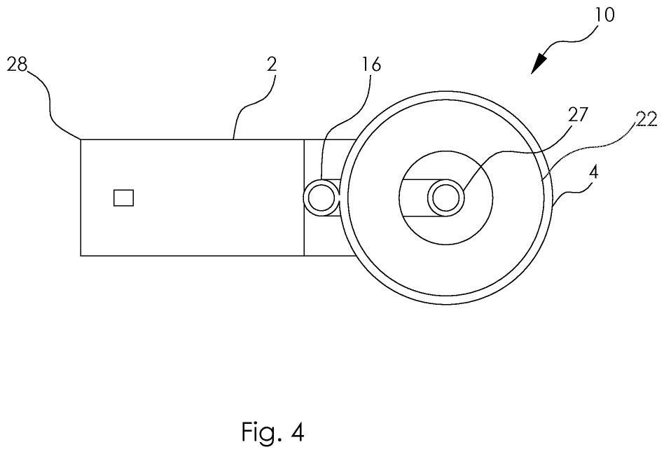

Further, in FIG. 1, gravity tapping system 1 may further include an air valve such as air valve 5. An external portion, such as external portion 16 of air valve 5, as shown in the FIG. 1 embodiment, may be cylindrical in shape and extends from a point externally on tapping device 10 and then internally into shank 2 (e.g. as shown in FIGS. 4, 5, and 7) and connects to siphoning straw 6. In one embodiment, air valve 5 may be capable of allowing air to travel from outside of tapping device 10, through external portion 16 of air valve 5, through the siphoning straw 6, and into the top of liquid container 3 (when the liquid is in an inverted position as shown in FIG. 1). By allowing air to flow into liquid container 3, tapping device 10 is capable of dispensing liquid faster and having a more even pour due to the balancing of the atmospheric pressure inside the liquid container with the outside atmospheric pressure of the liquid container.

In one embodiment, siphoning straw 6 may be an elongated tube-shaped straw that is connected to the internal portion of external portion 16 of the air valve 5 at a first end. It is noted that siphoning straw 6 may also be referred to as a self-sealing straw. In one embodiment, at a second end, the self-sealing straw 6 includes a self-sealing mechanism, such as self-sealing mechanism 12. Self-sealing mechanism 12 may include a bottom seal, such as bottom seal 8, a ball, such as ball 7, and a top holder such as top holder 9, as shown in FIG. 1. In one embodiment, when faucet 13 is in a closed position, liquid cannot flow through tapping device 10 from liquid container 3, and ball 7 is configured to rest upon bottom seal 8, thereby preventing oxygen from getting inside of liquid container 3, and also preventing any carbonation of liquid inside of liquid container 3 from leaking out. When faucet 13 is switched to an opened position and liquid starts to flow through tapping device 10 from liquid container 3, the atmospheric pressure inside of liquid container 3 may cause the ball 7 to float up and off the bottom seal 8. This is because the lowering of the liquid inside of liquid container 3 will cause air to flow through external portion 16 of air valve 5 and into liquid container 3, pushing the ball 7 off of the seal as the pressure inside of liquid container 3 wants to become equal with the outside pressure. In this embodiment, ball 7 is prevented from reaching the top of siphoning straw 6 by top holder 9, which allows air flow past ball 7 and into liquid container 3. Top holder 9 may have one or more grooves around its outer surface, whereby air is able to flow through these grooves and out of the top of the siphoning straw 6, so as to prevent ball 7 from blocking air flow at the top. Once faucet 13 is moved back into an off position, ball 7 may rest on top of bottom seal 8 again, thereby sealing and preventing the flow of air into liquid container 3. It is noted that in some embodiments, the siphoning straw 6 may be a normal straw and does not contain self-sealing mechanism 12.

Additionally, an exit port such as exit port 28 of tapping device 10 is shown in FIG. 1. Exit port 28, in one embodiment, may be an exit port for any liquid to flow out of tapping device 10. In the embodiment shown in FIG. 1, exit port 28 may be connected to faucet 13. Faucet 13, in this embodiment, may be connected to exit port 28 by using connector 14. In some embodiments, tapping device 10 may be connected to faucet 13 by screwing faucet 13 onto a threaded connector, a snap together washer connector, or a nut may be used to secure tapping device 10 and faucet 13. In other embodiments, any connection means may also alternatively be used to connect tapping device to faucet 13.

Faucet 13 may include an internal valve that is opened or closed with a faucet handle, such as faucet handle 15. When faucet handle 15 is moved to an open position, the faucet valve is opened, and liquid is able to flow through gravity tapping system 1. In this embodiment, when faucet handle 15 is in a closed position, the faucet valve (not shown) is closed, and liquid does not flow through gravity tapping system 1. In one non-limiting embodiment, faucet 13 may be any type of faucet, including faucets commonly found in keg systems. Further, in one embodiment, the faucet valve (not shown) may be a ball valve.

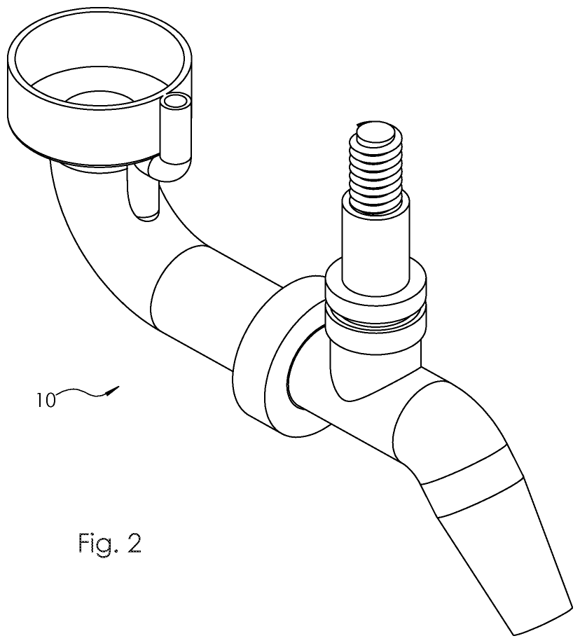

FIG. 2 is a perspective view of tapping device 10 of FIG. 1.

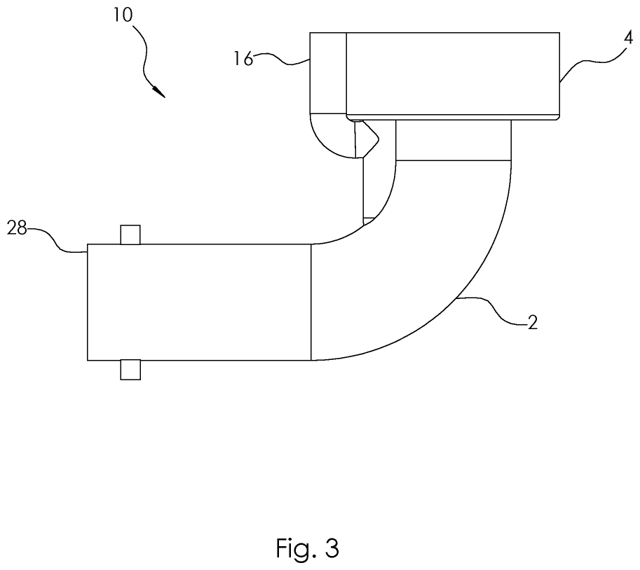

Turning to FIG. 3, FIG. 3 illustrates a side view of tapping device 10, as shown in FIG. 1, without a siphoning straw or faucet attached according to various aspects of the present disclosure. In this embodiment shown in FIG. 3, shank 2, exit port 28, connecting head 4, and external portion 16 of air valve 5 is shown. Exit port 28, in this embodiment, is not threaded and may be connected to faucet 13 with a securing washer or nut. In one embodiment, a two-piece securing washer may be used. In a further non-limiting embodiment, exit port 28 may be threaded.

Turning to FIG. 4, FIG. 4 shows a top down view of tapping device 10 as shown in FIG. 3. In this view as shown in FIG. 4, shank 2, connecting head 4, exit port 28, external portion 16 of air valve 5, and an internal portion such as internal portion 27 of air valve 5 are shown. Internal portion 27 and external portion 16 of air valve 5 refer to Gravity tapping system 1 when a growler or other liquid container may be attached and is in reference to external and internal to gravity tapping system 1. In this view, an internal cylindrical wall such as internal cylindrical wall 22 of connecting head 4 is shown. Internal cylindrical wall 22 in one embodiment may be threaded, and is used when connecting tapping device 10 to a threaded liquid container 3. In another non-limiting embodiment, internal cylindrical wall 22 may not be threaded and does not use threads to connect connecting head 4 to a growler or other liquid container 3. Rather, in such an alternative embodiment, internal cylindrical wall 22 may be connected viaa snap on method or any other attachment method.

Additionally, FIG. 4 shows external portion 16 of air valve 5 and internal portion 27 of air valve 5. Air valve 16 may be a continuous piece that extends from external portion 16, through shank 2, and terminating at or ending it internal portion 27. In this embodiment, by going through shank 2, air valve 5 is able to bring air from outside of tapping device 10, to the inside of liquid container 3.

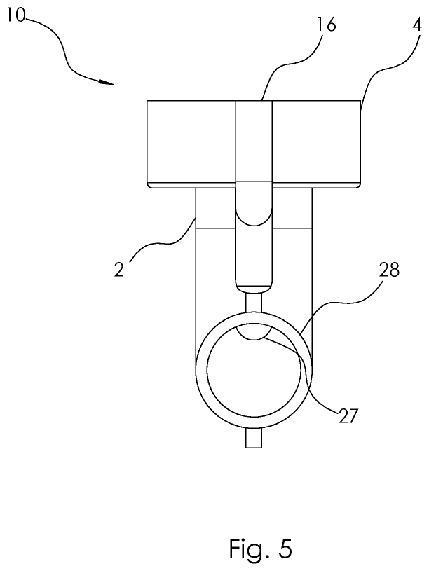

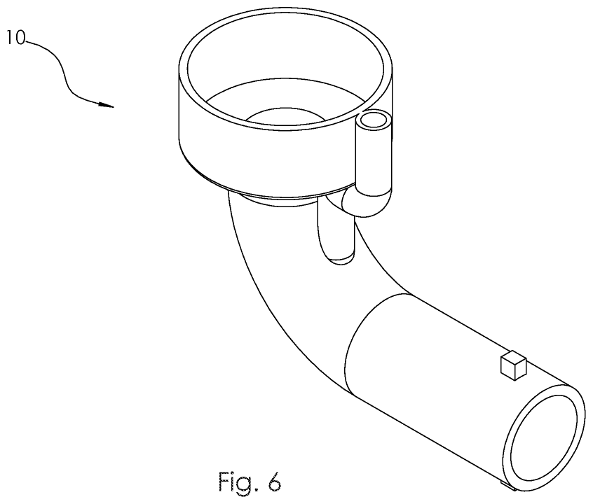

FIG. 5 shows a front view of the exemplary tapping device 10, including tapping device 10 as shown in FIG. 3. In this view, shank 2, exit port 28, external air valve portion 16, internal air valve portion 27, and connecting head 4 are shown. For further clarification, FIG. 6 shows a perspective view of tapping device 10 as show in its FIG. 3 configuration of the FIG. 1 embodiment.

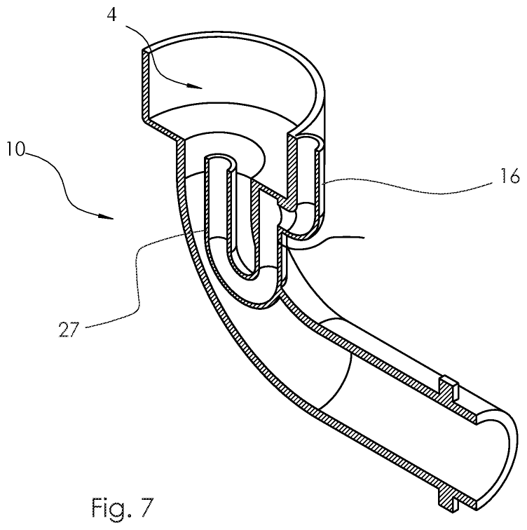

FIG. 7 shows a sectional view of tapping device 10 as shown in the FIG. 3 configuration of the FIG. 1 embodiment. This view shows how external portion 16 of air valve 5, in one or more embodiments, may lead into internal portion 27 of air valve 5.

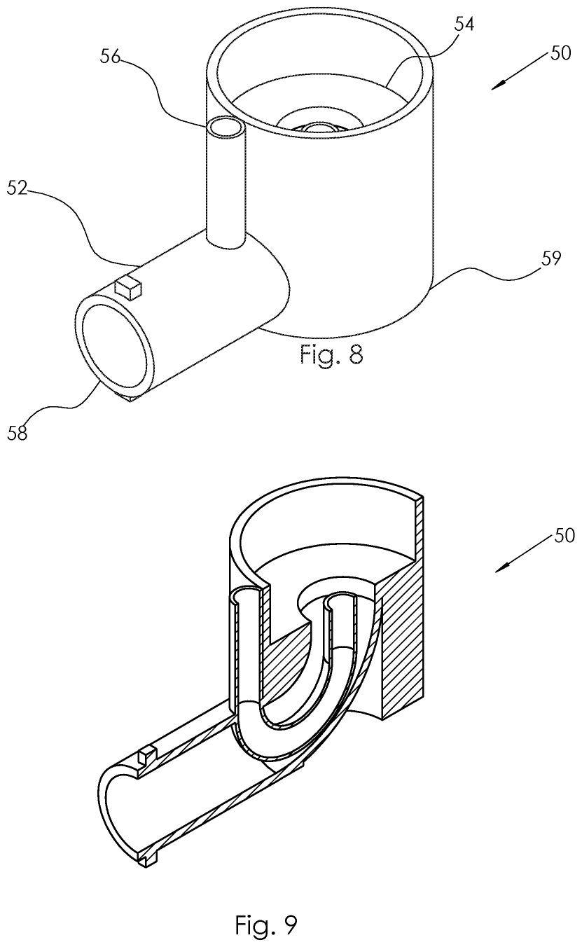

Turning to FIGS. 8 and 9, another embodiment of a tapping device 50, according to various aspects of the present disclosure, is shown. In this embodiment, a shank, such as shank 52, is configured to be more “L” shaped than curved. Additionally, shank 52 comprises a large round and flat base such as base 59. In this embodiment, base 59 is capable of supporting the weight of an attached liquid container (e.g. liquid container 3) and faucet (e.g. faucet 13). This embodiment allows a user to store tapping device 50 with an attached liquid container and faucet in their fridge. Tapping device 50, in operation, would sit on the edge of a fridge shelf with the faucet attached to exit port 58 hanging over said shelf. Base 59 is large and flat enough to prevent the liquid container from flipping over. Additionally, this embodiment shows external air valve portion such as external air valve portion 56 and connecting head such as connecting head 54. FIG. 9 is a sectional view of tapping device 50 as shown in the FIG. 8 embodiment.

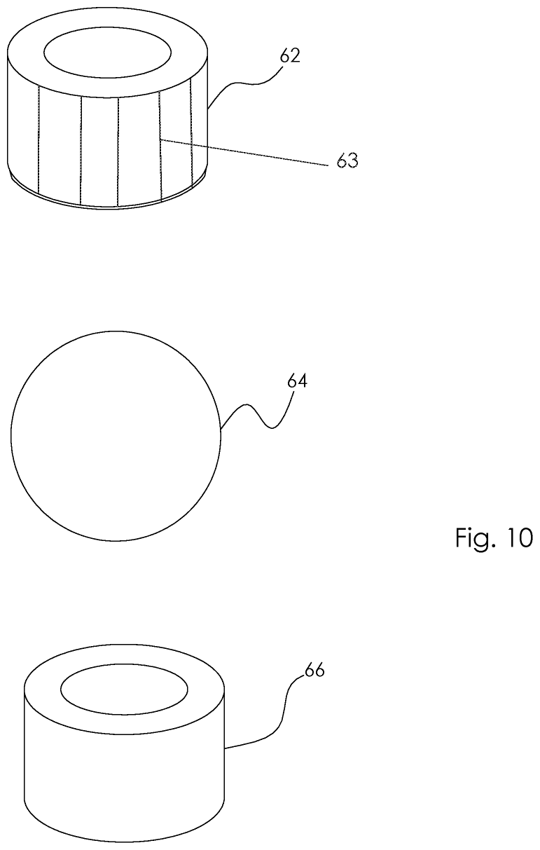

FIG. 10 is an isometric view of the components that make up a self-sealing portion of a siphoning straw like siphoning straw 6 as shown in, for example, FIG. 1, of the tapping device 10. In this embodiment, close up isometric views of a bottom seal such as bottom seal 66, a ball such as ball 64, and a top holder such as top holder 62 are shown. In one embodiment, bottom seal's 66 outside circumference is round and smooth. In this embodiment, the round and smooth outer circumference prevents air from leaking past bottom seal 66 in the self-sealing section as the smooth surface make an airtight seal with the inner surface of the siphoning straw. Additionally, in this embodiment top holder 62 is shown having ridges such as ridges 63 along the outside circumference. Ridges 63 may allow air to flow past top holder 62, as the point of top holder 62 is to prevent ball 64 from being lost out of the self-sealing section of the siphoning straw.

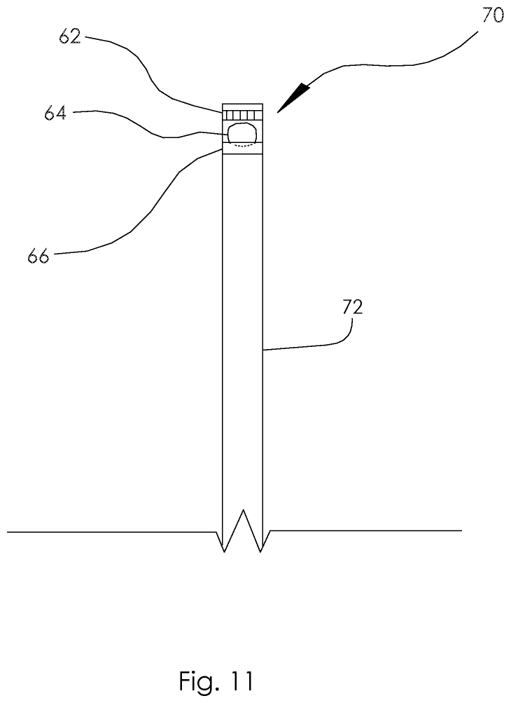

In FIG. 11, a side view is shown of a siphoning straw such as siphoning straw 72. Siphoning straw 72 may be a siphoning straw such as siphoning straw 3 as shown in the Figures above. Siphoning straw 72, as shown in FIG. 11, may illustrate when straw 72 is sealed with a sealing mechanism such as sealing mechanism 70. In this view, ball 64 may be resting on top of bottom seal 66, and beneath top holder 62. In operation, as the liquid starts to flow out of the system when the faucet (e.g. such as faucet 13) is moved to an open position, the air pressure inside of the liquid container may cause ball 64 to be pushed up by air flowing through siphoning straw 72 trying to get inside of the liquid container (e.g. liquid container 3). Ball 64 would then rest on top holder 62 which prevents ball 64 from going into the liquid container. The ridges 63 on top holder 62 would allow air to get into the liquid container, thereby allowing the liquid to be dispensed faster. When the faucet (e.g. faucet 13) is turned off, ball 64 would rest upon bottom seal 66, thereby sealing the system and preventing air from getting into, or escaping, the tapping system when not in use.

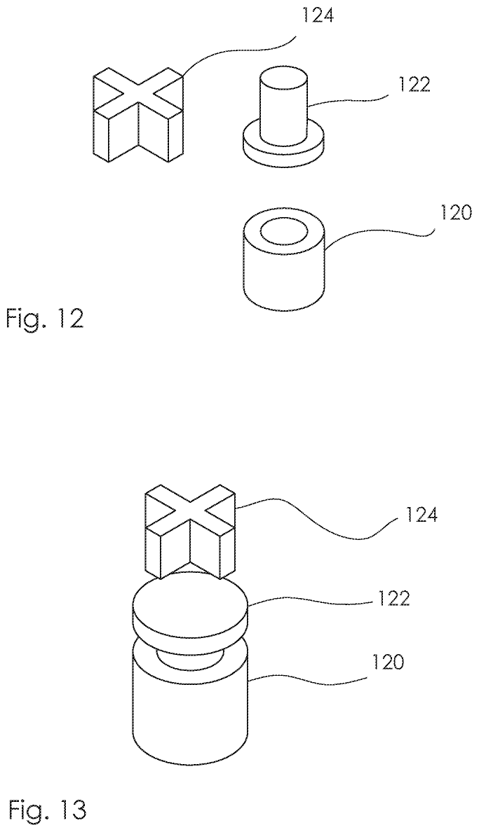

FIG. 12 is an isometric view of another embodiment of components that can make up a self-sealing portion of a siphoning straw, such as siphoning straw 13 as shown in, for example, FIG. 1. In this embodiment, close up isometric views of a bottom seal such as bottom seal 120, a sealer such as sealer 122, and a top holder top holder 124 are shown. In one embodiment, bottom seal's 120 outside circumference is round and smooth. In this embodiment, the round and smooth circumference prevents air from leaking past the bottom seal in the self-sealing section as the smooth surface make an airtight seal with the inner surface of the siphoning straw. Additionally, in this embodiment, top holder 124 is shown in an X shaped configuration that would prevent sealer 122 from escaping the self-sealing section and still allow air to flow through the siphoning straw during use. Sealer 122 is configured to be able to fit inside of bottom seal 120.

FIG. 13 is a side view of the FIG. 12 components as they would be arranged inside of a siphoning straw if used to make the self-sealing section. In this embodiment, bottom seal 120 may be located at the bottom and sealer 122 may be located in the middle, whereby sealer 122 is configured to be able to rest against bottom seal 120 when in the sealing position and raise up to allow air to flow through the system when the faucet is opened, and liquid is being dispensed through the tapping device. Top holder 124 prevents sealer 122 from flowing out of the siphoning straw and is configured to allow air to flow past.

It is noted that any of the tapping devices shown in FIGS. 1-13 may be formed from any suitable material, even if the cross-hatching used in any of these Figures may be illustrative of a particular type or kind of material.

Advantageously, the present description provides one or more embodiments of various types of tapping devices and one or more embodiments of a gravity tapping system. Each gravity tapping system depicted herein provides advantages that overcome shortcomings of other types of tapping devices that are used conventionally. Further, the various embodiments shown in the Figures and described herein accommodate different sized liquid containers and may be used in various applications, including, but not limited, to dispensing liquid from a liquid container. It is noted that the various embodiments of tapping devices presented herein may be used in many other ways other than presented above. For example, the various tapping devices may generally be used to dispense from a liquid container other than a growler. Thus, the various embodiments described in the present description include a number of novel and helpful components that provide enhanced tapping devices to benefit a user.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A tapping system, comprising:
a tapping device, the tapping device having an exit port;
a container, the container configured to connect to the tapping device in an inverted position, and wherein the container is configured to hold a liquid; and
a faucet, wherein the faucet is configured that when opened, the liquid in the container flows under forces of gravity and atmospheric pressure from the container through the tapping device and out the faucet.

2. The tapping device of claim 1, further comprising an air valve, the air valve having a first end and a second end.

3. The tapping device of claim 2, wherein the first end of the air valve is located internally within the tapping device and the second end of the air valve is located externally of the tapping device.

4. The tapping device of claim 3, further comprising a straw, wherein the straw is connected to the first end of the air valve.

5. The tapping device of claim 4, further comprising a shank, the shank having a curved tubular shape with a solid round exterior and hollow interior configured to facilitate the flow of the liquid, the first end of the air valve reaching internally into the shank.

6. The tapping device of claim 1, further comprising a connecting head configured to connect the tapping device to the container.

7. The tapping device of claim 6, the connecting head having a disk shape with a lower disk-shaped surface and a cylindrical side surface having a plurality of parallel striations defined thereon.

8. The tapping device of claim 7, wherein the cylindrical side surface of the connecting head is threaded on an inside surface configured to permit the tapping device to screw onto the container.

9. A tapping system, comprising:
a tapping device, the tapping device having an exit port;
a container, the container configured to connect to the tapping device in an inverted position, the container configured to hold a liquid;
a faucet, the faucet configured that when opened, the liquid flows under forces of gravity and atmospheric pressure from the container through the tapping device and out the faucet; and
a straw.

10. The tapping device of claim 9, the straw comprising a self-sealing mechanism.

11. The tapping device of claim 10, the self-sealing mechanism comprising a bottom seal, a ball, and a top holder, the self-sealing mechanism configured that when faucet is in a closed position, the liquid does not flow through the tapping device from the container, and the ball rests upon the bottom seal, preventing oxygen from getting inside of the container, and any carbonation of the liquid inside of the container from leaking out, while when faucet is an open position, the liquid flows through the tapping device from the container, wherein the atmospheric pressure inside of the container causes the ball to push off the bottom seal.

12. The tapping device of claim 12, the top holder having grooves around an outer circumference configured to permit air to flow out of a top of the straw, as to prevent the ball from blocking air flow at the top of the straw.

13. The tapping device of claim 12, the faucet comprising an internal valve that is opened or closed with a handle, wherein the handle is configured such that when moved to an open position, a faucet valve is opened, and the liquid flows through the faucet.

14. The tapping device of claim 12, wherein the straw is an elongated tube, wherein the straw is configured to connect to an air valve, the air valve having a first end and a second end.

15. The tapping device of claim 14, wherein the first end of the air valve is located internally within the tapping device and the second end is located externally of the tapping device.

16. The tapping device of claim 15, further comprising a shank, the shank having a curved tubular shape with a solid, round exterior and a hollow interior configured to facilitate the flow of the liquid, the first end of the air valve reaching internally into the shank.

17. A tapping system, comprising:
a tapping device, the tapping device having an exit port;
a container, the container configured to connect to the tapping device in an inverted position, wherein the container is configured to hold a liquid;
a faucet, the faucet configured that when opened, the liquid flows under forces of gravity and atmospheric pressure from the container through the tapping device and out the faucet; and
a shank, the shank configured to facilitate the flow of the liquid.

18. The tapping device of claim 1, the shank having an L-shape, the shank comprising a base, wherein the base is configured to support the weight of the container and the faucet, wherein the container and the faucet are configured not to rotate when the tapping device is placed on an edge of a surface and the faucet is hanging over the surface.

19. The tapping device of claim 18, the faucet comprising an internal valve that is opened or closed with a handle, wherein the handle is configured such that when moved to an open position, a faucet valve is opened, and the liquid flows through the faucet.

20. The tapping device of claim 1, further comprising an air valve, the air valve comprising a first end and a second end, wherein the first end of the air valve is located internally within the tapping device and the second end is located externally of the tapping device.
